(19) United States
(12) Patent Application Publication
(10) Pub. No.: US 2003/0043097 A1
(43) Pub. Date: Mar. 6, 2003

(54) Liquid crystal display device

(75) Inventors: Akira Shingai, Chiba (JP); Junichi Hirakata, Chiba (JP)

Correspondence Address: Stanley P. Fisher, Reed Smith LLP, Suite 1400, 3110 Fairview Park Drive, Falls Church, VA, 22042-4503, US

(73) Assignee: Hitachi, Ltd.

(21) Appl. No.: 10/144,936

(22) Filed: May 15, 2002

(30) Foreign Application Priority Data
Jun. 15, 2001 (JP) 2001-181031

(51) Int. Cl. G09G 3/36

(52) U.S. Cl. 345/87

(57) ABSTRACT

A liquid crystal display device having superior moving-image display characteristics are provided. In the liquid crystal display device, the timing of application of grayscale voltage to liquid crystal cells at the top end of its screen with respect to the timing of application of grayscale voltage to liquid crystal cells in the center of the screen and the timing of application of grayscale voltage to liquid crystal cells at the bottom end of the screen with respect to the timing of application of grayscale voltage to the liquid crystal cells in the center of the screen are made approximately coincident with each other or are deviated from each other by approximately one scanning-line selection period, and a liquid crystal panel is illuminated by a backlight which is intermittently lit in synchronism with vertical synchronizing signals.

### BACKGROUND OF THE INVENTION

1. Field of the Invention

The present invention relates to a liquid crystal display.

2. Background Art

A related art liquid crystal display device will be described below with reference to FIGS. 1, 3 and 4. FIG. 1 is a block diagram of a general liquid crystal display device. FIG. 3 shows the timing of a gate selecting signal which is generated from a general scanning driver circuit and is applied to a TFT liquid crystal display. FIG. 4 shows the transmissivity of liquid crystal cell, the luminance wave form of a backlight and a variation in the luminance of a liquid crystal panel in the case of applying grayscale voltage at the timing shown in FIG. 3 with causing the backlight to light intermittently in synchronism with vertical synchronizing signal.

In FIG. 1 101 denotes a data bus over which to transmit display data and a synchronizing signal which are inputte from an external device, 110 denotes a timing control circuit which generates various timing signals for a liquid crystal driver circuit, 111 denotes a data bus over which to transmit display data and a synchronizing signal which are generated by the timing control circuit 110, and 112 denotes a signal bus over which to transmit a synchronizing signal generated by the timing controll circuit 111. 113 denotes a signal driver circuit which generates grayscale voltages according to the display data transmitted over the data bus 111. 114 denotes the scanning driver circuit which sequentially selects a line to which to apply the grayscale voltage generated by signal driver circuit 113. 115 denotes a power source circuit, and 116 denotes a liquid crystal panel. 117 denotes drain line buses over which to transmit to the liquid crystal panel 116 the grayscale voltages generated by the signal driver circuit 113. 118 denotes gate line buses over which to transmit scanning voltages generated by the scanning driver circuit 114 to the liquid crystal panel 116. 119 denotes a power source bus over which to transmit a power source voltage to the signal driver circuit 113, and 120 denotes a power source bus over which to transmit a power source voltage to the scanning driver circuit 114.

The operation of the liquid crystal display device shown in. FIG. 1 wi 11 be described below in detail. Display data and a synchronizing signal which are inputted through the bus 101 from an external device are converted through the timing control device 110 into display data and a synchronizing signal which operate the signal driver circuit 113 and the scanning driver circuit 114, and the obtained display data and synchronizing signal are transmitted to the data bus 111 and the signal bus 112. The signal driver circuit 113 converts the display transmitted over the data bus 111 into a corresponding grayscale voltage, and outputs the corresponding grayscale voltage to the drain line buses 117. The grayscale voltage transmitted over the drain line buses 117 is applied to the liquid crystal panel 116, whereby the display data can be seen by the human eye in the form of a display luminance corresponding to the display data.

This operation will be described below with reference to FIGS. 3 and 4 which show the timing of scanning-line selection, a transmissivity 304 of liquid crystal cells lying at the top end of the screen, a transmissivity 305 of liquid crystal cells lying in the center of the screen, a transmissivity 306 of liquid crystal cell lying at the bottom end of the screen, a luminance 307 of the backlight which is driven to light intermittently in synchronism with the vertical synchronizing signal, a luminance variation 308 of the liquid crystal panel at the top end of the screen during a period of time in which the transmissivity of the liquid crystal cells lying at the top end of the screen is in its transient state before reaching its steady state, when a display image signal changes from black to white, a luminance variation 309 of the liquid crystal panel in the center of the screen during a period of time in which the transmissivity of the liquid crystal cells lying in the center of the screen is in its transient state before reaching its steady state, when the display image signal changes from black to white, a luminance variation 310 of the liquid crystal panel at the bottom end of the screen during a period of time in which the transmissivity of the liquid crystal cells lying at the bottom end of the screen is in its transient state before reaching its steady state, when the display image signal changes from black to white.

In a general liquid crystal display device having pixels arranged in M vertical columns and N horizontal rows, as shown in FIG. 3, wi thin a vertical write period (frame period) 301 (16.7 mS in the case of a screen display frequency of 60 Hz), the first scanning line is selected and the image display signal in the first line is converted into a corresponding grayscale voltage, and this grayscale voltage is outputted to the drain signal line buses to set the liquid crystal cells to the desired transmissivity. Subsequently, scanning-line selection, the outputting of grayscale voltage to the drain line buses, and the setting of the transmissivity of the liquid crystal cells are sequentially repeated in the order of the second line, the third line and so on. The setting of the transmissivity of liquid crystal cells for one screen is completed with the setting of the transmissivity of the liquid crystal cells on the N-th line. The grayscale voltages which have been set for the respective liquid crystal cells are held in the capacitances of the respective liquid crystal cells and in storage capacitances provided in the respective liquid crystal cells, until the individual liquid crystal cells are subjected to the next setting cycle, i.e., scanning-line selection, the outputting of grayscale voltage to the drain line buses and the setting of the transmissivity of the liquid crystal cells.

FIG. 4 shows the relationship among the transmissivities of the liquid crystal cells, the luminance of the backlight and the luminance of the liquid crystal panel in the case where scanning-line selection is performed at the timing shown in FIG. 3 and the backlight is driven to light intermittent Iy in synchronism with the vertical synchronizing signal.

In the case where the lighting start timing of the backlight is set so that the luminance variation of the liquid crystal panel in the center of the screen becomes most natural while a moving image is being displayed on the TFT liquid crystal display, the luminance waveform of the backlight becomes as shown in FIG. 4.

In other words, assuming that the luminance response of the backlight to a backlight blinking control signal is faster than the response of the transmissivity variation of the liquid crystal cells to the application of grayscale voltage to the liquid crystal cells, when, after the application of grayscale voltage to the liquid crystal cells in the center of the screen, a backlight lighting start signal is applied to switch the backlight from off to on, for example in the case where display data is changed from black to white, the time required for a variation in the luminance of the liquid crystal panel becomes apparently faster than that required for a variation in transmissivity of the liquid crystal cells.

According to documents such as Examination of Moving Image Quality of Hold Emission Type Display Using 8 Times Speed CRT (Technical Report of The Institute Of Electronics, Information and Communication Engineers, EID 96-4, pp. 19-26, June 1996) or Examination of Viewing Mechanism During Display of Moving Image on Hold Type Display (Technical Report of The Institute of Image Information and Television Engineers, Vol. 122, No. 17, pp. 19-24, March 1998), it has been known that if a moving image is displayed on a TFT liquid crystal display, a degradation of image quality which is called a moving-image blur occurs owing to the fact that grayscale voltages are held in its liquid crystal cells for one frame period.

A CRT generally emits light for as short as ⅛ of one frame period (16.7 mS in the case of a screen display frequency of 60 Hz), and continues to display black for the remaining period. In this form of emission, moving-image blur does not occur. For this reason, various methods of coping with moving-image blur by inserting periods in which no image is displayed have been proposed with respect to TFT liquid crystal displays.

A method of inserting a period in which no image is displayed, as countermeasures against moving-image blur, is disclosed in Japanese Patent Laid-Open Nos. 109921/1999 and 293142/2000.

The intermittent lighting of the backlight in synchronism with the vertical synchronizing signal 302 shown in FIG. 4 is in tended for such countermeasures against moving-image blur. As described above, the lighting start timing of the backlight is set so that the luminance variation of the liquid crystal panel in the center of the screen becomes most natural. Therefore, the luminance of the liquid crystal panel gradually increases like the luminance 309 of the liquid crystal panel during the period of time in which the transmissivity of the liquid crystal cells lying in the center of the screen is in the transient state before reaching the steady state, when display data in the center of the screen changes from black to white. Furthermore, the luminance variation of the liquid crystal panel becomes faster than the response of the transmissivity variation of the liquid crystal panel to the application of grayscale voltage to the liquid crystal panel. Accordingly, it is possible to realize only the advantage of the countermeasures against moving-image blur due to the insertion of a predetermined length of off period in the period of the backlight.

### SUMMARY 0F THE INVENTION

However, at the top end of the screen, the transient response period of back light extinction and the transient response period of the transmissivity of the liquid crystal cells over lap each other, so that while the luminance of the liquid crystal panel changes from black to white as shown at 308 in FIG. 4 (308: the luminance of the liquid crystal panel during a change from black to white at the top end of the screen) , light of low luminance is emitted from the liquid crystal panel. Within the write period 301, the next time at which the top end of the screen emits is the timing at which the backlight starts lighting, and the luminance of the liquid crystal panel at that time varies similarly the luminance of the backlight.

The present inventor has newly discovered that after light of low luminance (an image of low contrast) has once been seen by the human eye, light of high luminance (an image of high contrast) can be seen by the human eye, and this phenomenon leads to the problem that while an image is moving, the contour of the image is seen double.

The present inventor has also discovered that at the bottom end of the screen, while an image is changing from black to white, the luminance of the liquid crystal panel does not gradually increase, so that while a moving image is being displayed, the contour of the image is seen double.

Furthermore, since the top and bottom ends of the screen differ in the manner of luminance variation of the liquid crystal panel, the top and bottom ends of the screen cannot be improved at the same time under conditions which optimize the state of displ ay of a moving image in the center of the screen. Even if an are a in which the luminance variation of the liquid crystal panel becomes most natural is moved from the center toward the top or bottom of the screen by deviating the lighting start timing of the backlight, it is impossible to improved the top end and the bottom end of the screen, because the manner of the luminance variation of the liquid crystal panel is asymmetrical at the top end and the bottom end of the screen.

When image display data changes from black to white in an area except the top end, the center and the bottom end of the screen, the liquid crystal panel shows the following luminance variation. Scanning-line selection is sequentially performed to start at the first line and complete at the N-th line, i.e., the application of grayscale voltage to the liquid crystal cells are temporally sequentially delayed (deviated), so that the luminance of the liquid crystal panel gradually vari es from the luminance 308 which occurs in the liquid crystal panel at the top end of the screen during a period of time in which the transmissivity of the liquid crystal cells lying at the top end of the screen is in its transient state before reaching its steady state, when display data at the top end of the screen changes from black to white. Subsequently, the luminance of the liquid crystal panel reaches the luminance 309 of the liquid crystal panel in the center of the screen as well as the luminance 310 of the liquid crystal panel at the bottom end of the screen.

Therefore, when a moving image is displayed in the center of the screen, its contour is not seen double, but the contour becomes seen gradually double toward the top or bottom end of the screen, and the manner in which the double contour is seen differs between the top and bottom ends of the screen. In the above-described method, the timing of application of grayscale voltage to the liquid crystal cells at the top end of the screen with respect to the timing of application of grayscale voltage to the liquid crystal cells in the center of the screen and the timing of application of grayscale voltage to the liquid crystal cells at the bottom end of the screen with respect to the timing of application of grayscale voltage to the liquid crystal cells in the center of the screen are asymmetrical to each other; that is to say, the timing of application of grayscale voltage to the liquid crystal cells at the top end of the screen is earlier than the timing of application of grayscale voltage to the liquid crystal cells in the center of the screen, while the timing of application of grayscale voltage to th e liquid crystal cells at the bottom end of the screen is later than the timing of application of grayscale voltage to the liquid crystal cells in the center of the screen. As a result, a moving image obtained from the countermeasures against moving-image blur that are taken by causing the backlight to light intermittently in synchronism with vertical synchronizing signals suffers a double contour which is asymmetrical in the top and bottom portions of the screen. A degradation of image quality due to this double contour which occurs asymmetrically in the top and bottom portions of the screen cannot be substantially ameliorated even if the lighting start timing of the backlight which is intermittently lit in synchronism with the vertical synchronizing signal is deviated.

Therefore, the invention provides a liquid crystal display device which can display a high-quality image by reducing a double contour which occurs asymmetrically in the top and bottom port ions of its screen during the display of a moving image and which cannot be substantially solved by existing countermeasures against moving-image blur which cause a back light to light intermittently in synchronism with vertical synchronizing signals.

Several means for solving above problem are as follows.

(1) A liquid crystal display device according to the invention includes: a liquid crystal panel having a plurality of drain signal lines and a plurality of scanning signal lines on at least one of a pair of substrates disposed in opposition to each other, and a liquid crystal layer clamped between the pair of substrates; a display control unit which applies a voltage according to a display image signal on the basis of a display image signal and a timing signal which are externally inputted; and a light source which illuminates the liquid crystal panel. In the liquid crystal display device, selection of the scanning signal lines is started with a line lying at one end of a screen and with a line Iying at the other end of the screen, and scanning-signal-line selection started at the one end of the screen is sequentially performed to proceed toward the other end of the screen, while scanning-signal-line selection started at the other end of the screen is sequentially per formed to proceed toward the one end of the screen. Scanning-signal-line selection in an area corresponding to a display are a of the liquid crystal panel is completed when the scanning-signal-line selection started at the one end of the screen and the scanning-signal-line selection started at the other end of the screen respectively select most mutually adjacent separate scanning signal lines. The light source which illuminates the liquid crystal panel is lit and extinguished in a predetermined relationship with writing of the display image signal to the screen.

(2) A liquid crystal display device according to the invention includes: a liquid crystal panel having a plurality of drain signal lines and a plurality of scanning signal lines on at least one of a pair of substrates disposed in opposition to each other, and a liquid crystal layer clamped between the pair of substrates; a display control unit which applies a voltage according to a display image signal on the basis of a display image signal and a timing signal which are externally inputted; and a light source which illuminates the liquid crystal panel. In the liquid crystal display device, selection of the scanning signal lines is sequentially performed to proceed from one of adjacent scanning signal lines toward one end of a screen and to proceed from the other of the adjacent scanning signal lines toward the other end of the screen, and the light source which illuminates the liquid crystal panel is lit and extinguished in a predetermined relationship with writing of the display image signal to the screen.

(3) A liquid crystal display device according to the invention includes: a liquid crystal panel having a plurality of drain signal lines and a plurality of scanning signal lines on at least one of a pair of substrates disposed in opposition to each other, and a liquid crystal layer clamped between the pair of substrates; a display control unit which applies a voltage according to a display image signal on the basis of a display image signal and a timing signal which are externally inputted; and a light source which illuminates the liquid crystal panel. In the liquid crystal display device, selection of the scanning signal lines is started with a line lying at one end of a screen and with a line lying at the other end of the screen, and scanning-signal-line selection started at the one end of the screen is sequentially performed to proceed toward the other end of the screen, while scanning-signal-line selection started at the other end of the screen is sequentially performed to proceed toward the one end of the screen. The scanning-signal-line selection started at the one end and the scanning-signal-line selection started at the other end are alternately performed, and scanning-signal-line selection in an area corresponding to a display area of the liquid crystal panel is completed when the scanning-signal-line selection started at the one end of the screen and the scanning-signal-line selection started at the other end of the screen respectively select most mutually adjacent separate scanning signal lines. The light source which illumimnates the liquid crystal panel is lit and extinguished in a predetermined relationship with writing of the display image signal to the screen.

(4) A liquid crystal display device according to the invention includes: a liquid crystal panel having a plurality of drain signal lines and a plurality of scanning signal lines on at least one of a pair of substrates disposed in opposition to each other, and a liquid crystal layer clamped between the pair of substrates; a display control unit which applies a voltage according to a display image signal on the basis of a display image signal and a timing signal which are externally inputted; and a light source which illuminates the liquid crystal panel. In the liquid crystal display device, selection of the scanning signal lines is sequentially performed to proceed from one of adjacent scanning signal lines toward one end of a screen and to proceed from the other of the adjacent scanning signal lines toward the other end of the screen, and scanning-signal-line selection which proceeds from the one of the adjacent scanning signal lines toward the one end of the screen and scanning-signal-lin e selection which proceeds from the other of the adjacent scanning signal lines toward the other end of the screen are alternately performed. The light source which illuminates the liquid crystal panel is lit and extinguished in a predetermined relationship with writing of the display image signal to the screen.

(5) A liquid crystal display device according to the invention includes: a frame memory which stores display data inputted from an external device; a unit which arranges the display data stored in the frame memory, in the desired order of scanning-line selection, and applies a grayscale voltage according to the display data to a liquid crystal panel; and a control unit which lights and extinguishes an illuminating power source which blinks a light source for illuminating the liquid crystal panel, in synchronism with a vertical synchronizing signal with in a period in which one image is displayed.

(6) A liquid crystal display device according to the invention includes: a liquid crystal panel having a plurality of drain signal lines and a plurality of scanning signal lines on at least one of a pair of substrates disposed in opposition to each other, and a liquid crystal layer clamped between the pair of substrates; a display control unit which applies a voltage according to a display image signal on the basis of a display image signal and a timing signal which are externally inputted; and a light source which illuminates the liquid crystal panel. In the liquid crystal display device, selection of the scanning signal lines is started with a line lying at one end of a screen and with a line Iying at the other end of the screen, and scanning-signal-line selection started at the one end of the screen is sequentially performed to proceed toward the other end of the screen, while scanning-signal-line selection started at the other end of the screen is sequentially performed to proceed toward the one end of the screen. The light source which illuminates the liquid crystal panel is intermittently lit.

(7) A liquid crystal display device according to the invention includes: a liquid crystal panel having a plurality of drain signal lines and a plurality of scanning signal lines on at least one of a pair of substrates disposed in opposition to each other, and a liquid crystal layer clamped between the pair of substrates; a display control unit which applies a voltage according to a display image signal on the basis of a display image signal and a timing signal which are externally inputted; and a light source which illuminates the liquid crystal panel. In the liquid crystal display device, selection of the scanning signal lines is sequentially performed to proceed from one of adjacent scanning signal lines toward one end of a screen and to proceed from the other of the adjacent scanning signal lines toward the other end of the screen, and the light source which illuminates the liquid crystal panel is intermittently lit.

(8) A liquid crystal display device according to the invention includes: a liquid crystal panel having a plurality of drain signal lines and a plurality of scanning signal lines on at least one of a pair of substrates disposed in opposition to each other, and a liquid crystal layer clamped between the pair of substrates; a display control unit which applies a voltage according to a display image signal on the basis of a display image signal and a timing signal which are externally inputted; and a light source which illuminates the liquid crystal panel. In the liquid crystal display device, selection of the scanning signal lines is started with a line lying at one end of a screen and with a line lying at the other end of the screen, and scanning-signal-line selection started at the one end of the screen is sequentially performed to proceed toward the other end of the screen, while scanning-signal-line selection started at the other end of the screen is sequentially performed to proceed toward the one end of the screen. The scanning-signal-line selection started at the one end and the scanning-signal-line selection started at the other end are alternately performed, and the light source which illuminates the liquid crystal panel is intermittently lit.

(9) A liquid crystal display device according to the invention includes: a liquid crystal panel having a plurality of drain signal lines and a plurality of scanning signal lines on at least one of a pair of substrates disposed in opposition to each other, and a liquid crystal layer clamped between the pair of substrates; a display control unit which applies a voltage according to a display image signal on the basis of a display image signal and a timing signal which are externally inputted; and a light source which illuminates the liquid crystal panel. In the liquid crystal display device, selection of the scanning signal lines is sequentially performed to proceed from one of adjacent scanning signal lines toward one end of a screen and to proceed from the other of the adjacent scann ing signal lines toward the other end of the screen, and scanning-signal-line selection which proceeds from the one of the adjacent scanning signal lines toward the one end of the screen and scanning-signal-line selection which proceeds from the other of the adjacent scanning signal lines toward the other end of the screen are alternately performed. The light source which illuminates the liquid crystal panel is intermittently lit.

(10) In a liquid crystal display device as in (6), scanning-signal-line selection in an area corresponding to a display area of the liquid crystal panel is completed when the scanning-signal-line selection started at the one end of the screen and the scanning-signal-line selection started at the other end of the screen respectively select most mutually adjacent separate scanning signal lines.

(11) A liquid crystal display device as in (6) further includes a scanning driver circuit which supplies scanning signals to the scanning signal lines and signal driver circuits which supply video signals to video signal lines. The signal driver circuits are disposed on the top side and the bottom side of the liquid crystal display device, and the video signal lines are connected to either one of the signal driver circuits disposed on the top side and the bottom side.

(12) In a liquid crystal display device as in (7), the selection of the scanning signal lines which proceeds toward the one end of the screen and the selection of the scanning signal lines which proceeds toward the other end of the screen are performed at approximately the same time.

(13) In a liquid crystal display device as in (11), the selection of the scanning signal lines which proceeds toward the one end of the screen and the selection of the scanning signal lines which proceeds toward the other end of the screen are performed at approximately the same time.

(14) A liquid crystal display device as in (7) further includes a scanning driver circuit which supplies scanning signals to the scanning signal lines and signal driver circuits which supply video signals to video signal lines. The signal driver circuits are disposed on the top side and the bottom side of the liquid crystal display device, and the video signal lines are connected to either one of the signal driver circuits disposed on the top side and the bottom side.

(15) In a liquid crystal display device as in (7), the selection of the scanning signal lines sequentially performed to proceed from the one of the adjacent scanning signal lines toward the one end of the screen and to proceed from the other of the adjacent scann ing signal lines toward the other end of the screen are per formed at approximately the same time.

In the liquid crystal display device according to the invention described in any of (1) to (15), the timing of application of grayscale voltage to the liquid crystal cells at the top end of the screen with respect to the timing of application of grayscale voltage to the liquid crystal cells in the center of the screen and the timing of application of grayscale voltage to the liquid crystal cells at the bottom end of the screen with respect to the timing of application of grayscale voltage to the liquid crystal cells in the center of the screen are made closer to each other or symmetrical to each other on the top and bottom sides of the screen, whereby the setting margin of the lighting start timing of a back light can be enlarged. Accordingly, it is possible to provide a liquid crystal display device capable of reducing a double contour which occurs asymmetrically on the top and bottom sides of its screen during the display of a moving image owing to countermeasures against moving-image blur which are taken by causing the backlight to light intermittently in synchronism with vertical synchronizing signals.

Further aspects and advantages of the invention will become apparent from the following description.

### BRIEF DESCRIPTION OF THE DRAWINGS

The invention will become more readily appreciated and understood from the following detailed description of preferred embodiments of the invention when taken in conjunction with the accompanying drawings, in which:

FIG. 1 is a block diagram of a related art liquid crystal display device

FIG. 2 shows one example of a block diagram of a liquid crystal display device according to the invention;

FIG. 3 is a timing chart showing a scanning-line selection method used in a related art;

FIG. 4 is a timing chart showing the transmissivities of liquid crystal cells at the top end of a screen, in the center of the screen and at the bottom end of the screen, as well as a backlight luminance and a luminance of a liquid crystal panel in the related art;

FIG. 5 is a timing chart showing a scanning-line selection method used in one embodiment of the invention;

FIG. 6 is a timing chart showing the transmissivities of liquid crystal cells at the top end of a screen, in the center of the screen and at the bottom end of the screen, as well as a backlight luminance and a luminance of a liquid crystal panel in one embodiment of the invention;

FIG. 7 is a timing chart showing a scanning-line selection method used in one embodiment of the invention;

FIG. 8 is a timing chart showing the transmissivities of the liquid crystal cells at the top end of the screen, in the center of the screen and at the bottom end of the screen as well as the backlight luminance and the luminance of the liquid crystal panel in one embodiment of the invention;

FIG. 9 is a timing chart showing a scanning-line selection method used in one embodiment of the invention;

FIG. 10 is a timing chart showing the transmissivities of the liquid crystal cells at the top end of the screen, in the center of the screen and at the bottom end of the screen as well as the backlight luminance and the luminance of the liquid crystal panel in one embodiment of the invention;

FIG. 11 is a timing chart showing a scanning-line selection method used in one embodiment of the invention;

FIG. 12 is a timing chart showing the transmissivities of the liquid crystal cells at the top end of the screen, in the center of the screen and at the bottom end of the screen as well as the backlight luminance and the luminance of the liquid crystal panel in one embodiment of the invention;

FIG. 13 is a timing chart showing a scanning-line selection method used in one embodiment of the invention;

FIG. 14 is a timing chart showing the transmissivities of the liquid crystal cells at the top end of the screen, in the center of the screen and at the bottom end of the screen as well as the backlight luminance and the luminance of the liquid crystal panel in one embodiment of the invention;

FIG. 15 is a driving timing chart showing a scanning-line selection method used in one embodiment of the invention;

FIG. 16 is a timing chart showing the transmissivities of the liquid crystal cells at the top end of the screen, in the center of the screen and at the bottom end of the screen as well as the backlight luminance and the luminance of the liquid crystal panel in one embodiment of the invention;

FIG. 17 is a block diagram of another liquid crystal display device according to the invention;

FIG. 18 is a timing chart showing a scanning-line selection method used in one embodiment of the invention;

FIG. 19 is a timing chart showing the transmissivities of the liquid crystal cells at the top end of the screen, in the center of the screen and at the bottom end of the screen as well as the backlight luminance and the luminance of the liquid crystal panel in one embodiment of the invention;

FIG. 20 is a timing chart showing a scanning-line selection method used in one embodiment of the invention;

FIG. 21 is a timing chart showing the transmissivities of the liquid crystal cells at the top end of the screen, in the center of the screen and at the bottom end of the screen as well as the backlight luminance and the luminance of the liquid crystal panel in one embodiment of the invention;

FIG. 22 is a schematic cross-sectional view aiding in describing an example of the construction of a direct backlight which uses a cold-cathode fluorescent lamp as its light source according to one embodiment of the invention

FIG. 23 is a timing chart showing the transmissivities of the liquid crystal cells at the top end of the screen, in the center of the screen and at the bottom end of the screen as well as the backlight luminance and the luminance of the liquid crystal panel in one embodiment of the invention;

FIG. 24 is a timing chart showing a scanning-line selection method according to one embodiment of the invention;

FIG. 25 is a timing chart showing a scanning-line selection method according to one embodiment of the invention;

FIG. 26 is a timing chart showing a scanning-line selection method according to one embodiment of the invention; and

FIG. 27 is a timing chart showing a scanning-line selection method according to one embodiment of the invention.

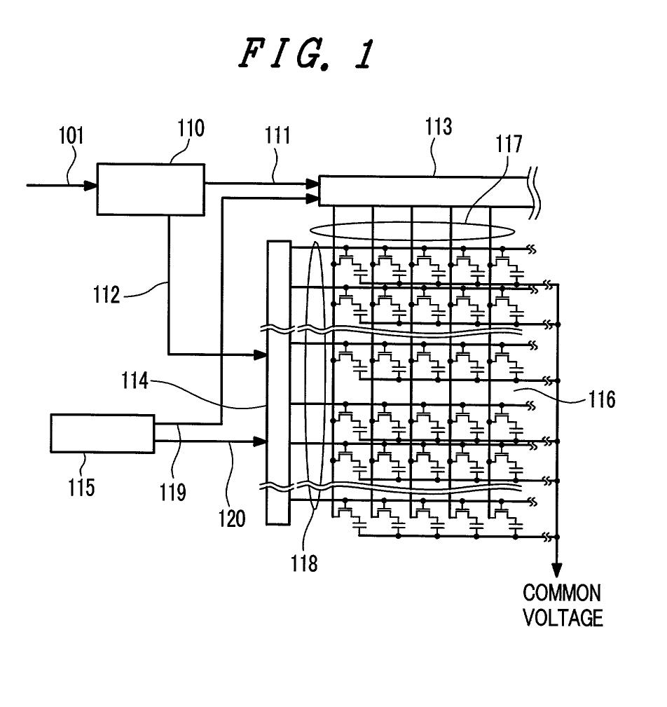

### DETAILED DESCRIPTION OF THE INVENTION

Preferred embodiments of the invention will be described below with reference to the drawings of the preferred embodiments.

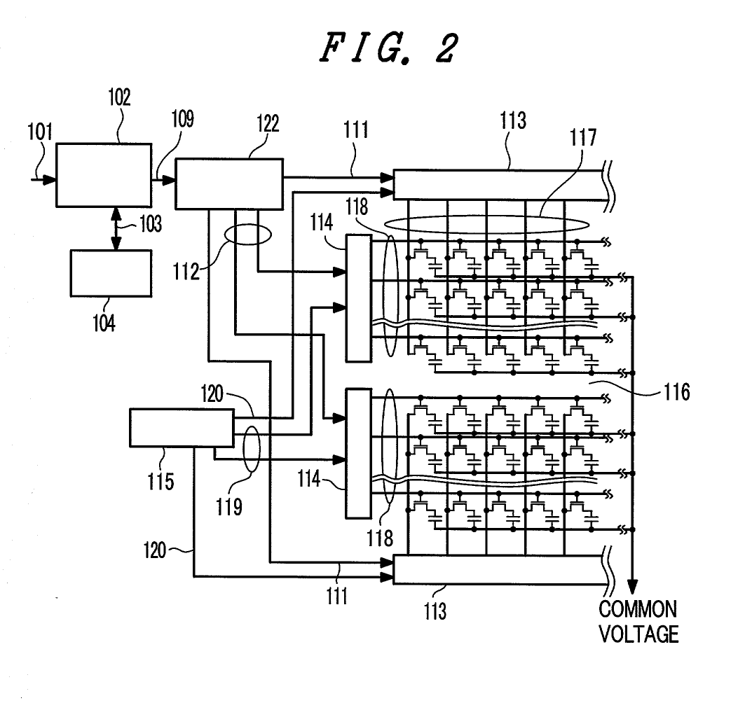

FIG. 2 is a block diagram of a liquid crystal display device which realizes the invention. In FIG. 2, a light source which illuminates a liquid crystal panel and an illuminating device which blinks the light source are omitted.

In FIG. 2, 101 denotes a bus over which to transmit display data and a synchronizing signal which are inputted from an external device, 102 denotes a frame memory control circuit, 103 denotes a frame memory controll bus, 104 denotes a frame memory, and 109 denotes a bus over which to transmit display data and synchronizing signals which are arranged in the desired order of scanning-line selection by the frame memory 104 and the frame memory control circuit 102. 122 denotes a timing control circuit which generates various timing signals for a liquid crystal driver circuit, 111 denotes buses over which to transmit display data and a synchronizing signal which are generated by the timing control circuit 122, and 112 denotes buses over each of which a synchronizing signal generated by the timing control circuit 122 is to be transmitted to a corresponding one of scanning driver circuits 114. 113 denotes signal driver circuits which generate grayscale voltages according to the display data transmitted over the corresponding ones of the buses 111. 114 denotes the scanning driver circuits each of which sequentially selects lines to which to apply the grayscale voltage generated by the corresponding one of the signal driver circuits 113. 115 denotes a power source circuit, and 116 denotes a liquid crystal panel. 117 denotes drain line buses over which to transmit to the liquid crystal panel 116 the grayscale voltages generated by the signal driver circuits 113. 118 denotes gate line buses over which to transmit scanning voltages generated by the scanning driver circuits 114 to the liquid crystal panel 116. 119 denotes power source buses over which to transmit power source voltages to the respective scanning driver circuits 114, and 120 denotes power source buses over which to transmit power source voltages to the respective signal driver circuits 113.

In the liquid crystal display device shown in FIG. 2, two scanning driver circuits 114 and two signal driver circuits 113 are provided for performing scanning-line selection by two lines at a time.

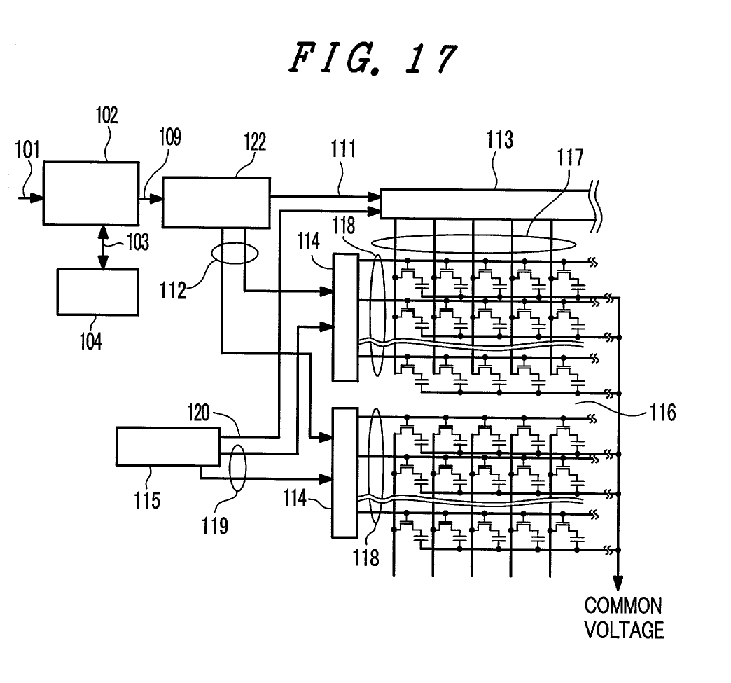

FIG. 17 is a block diagram of another liquid crystal display device which is constructed to select one scanning signal line at a time. In FIG. 17, a light source which illuminates a liquid crystal panel and an illuminating device which blinks the light source are omitted. In FIG. 17, s are the same as those used in FIG. 2. One signal driver circuit 113 is provided for selecting one scanning signal line at a time. Two scanning driver circuits 114 are provided for alternately selecting scanning signal lines in the top and bottom portions of the screen of the liquid crystal display device.

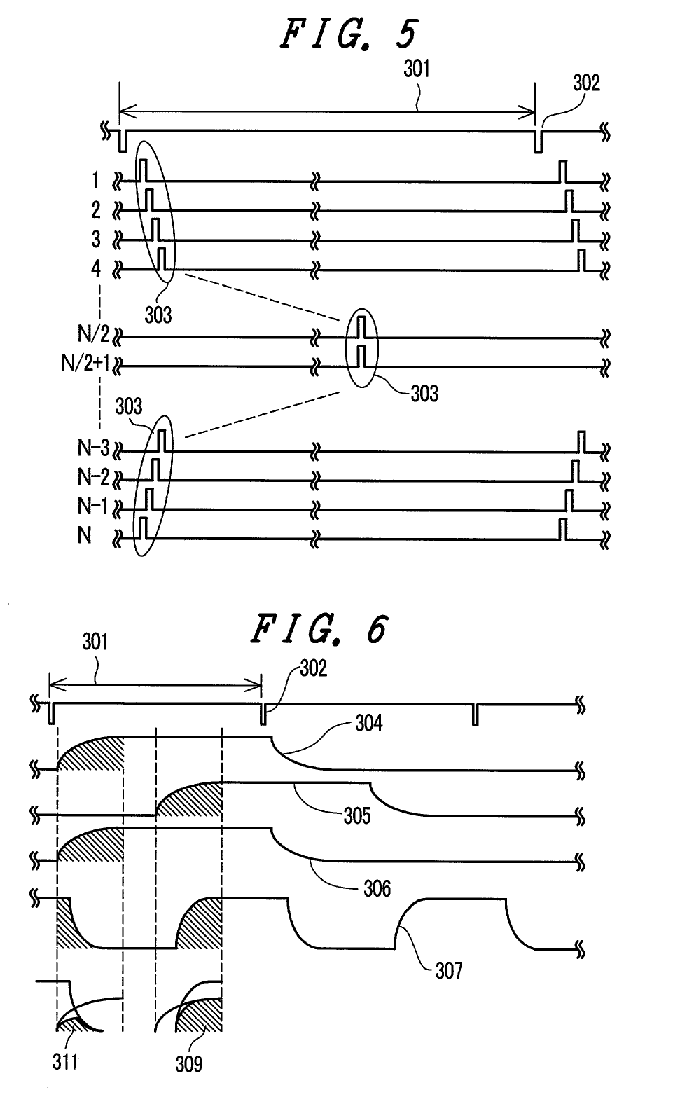

Preferred embodiments of the invention will be described below with reference to FIGS. 5 to 23.

FIGS. 5 and 6 are driving timing charts of a liquid crystal display device according to a first embodiment of the invention.

In FIGS. 5 and 6, 301 denotes a vertical write period (frame period), 302 denotes a vertical synchronizing signal 303 denotes a scanning-line selecting signal (gate-line selecting signal), 304 denotes the transmissivity of liquid crystal cells lying at the top end of the screen of the liquid crystal display device, 305 denotes the transmissivity of liquid crystal cells lying in the center of the screen, and 306 denotes the transmissivity of liquid crystal cells lying at the bottom end of the screen, 307 denotes a back light luminance. 309 denotes the luminance of the liquid crystal panel in the center of the screen during a period of time in which the transmissivity of the liquid crystal cells lying in the center of the screen is in its transient state before reaching its steady state, when display data in the center of the screen changes from black to white. 311 denotes the luminance of the liquid crys tal panel at each of the top and bottom ends of the screen during a period of time in which the transmissivity of the liquid crystal cells lying at each of the top and bottom ends of the screen is in its transient state before reaching its steady state, when display data at each of the top and bottom ends of the screen changes from black to white.

In the first embodiment, selection of scanning signal lines of a liquid crystal panel having N number of scanning signal lines and N lines of scanning electrodes is carried out at the timing shown in FIG. 5 by using the block diagram of the liquid crystal display device shown in FIG. 2 by the following method: Scanning-line selections are respectively started with the first line and the N-th line at the same time, and the scanning-line selection started with the first line is performed sequentially downwardly of the screen, while the scanning-line selection started with the N-th line is performed sequentially upwardly of the screen. The selection of scanning signal lines for one image is completed with the selection of both the (N/2)-th line and the (N/2+1) -th line. In this method, the relationship shown in FIG. 6 is achieved among: the transmissivity 304 of the liquid crystal cells at the top end of the screen, the transmissivity 305 of the liquid crystal cells in the center of the screen, the transmissivity 306 of the liquid crystal cells at the bottom end of the screen, and the backlight luminance 307, all of which are obtained when grayscale voltages corresponding to display data are applied to the liquid crystal cells of the liquid crystal panel; the luminance 309 of the liquid crystal panel in the center of the screen during the period of time in which the transmissivity of the liquid crystal cells lying in the center of the screen is in the transient state before reaching the steady state, when display data in the center of the screen changes from black to white; and the luminance 311 of the liquid crystal panel at each of the top and bottom ends of the screen during the period of time in which the transmissivity of the liquid crystal cells lying at each of the top and bottom ends of the screen is in the transient state before reach ing the steady state, when displ ay data at each of the top and bottom ends of the screen changes from black to white.

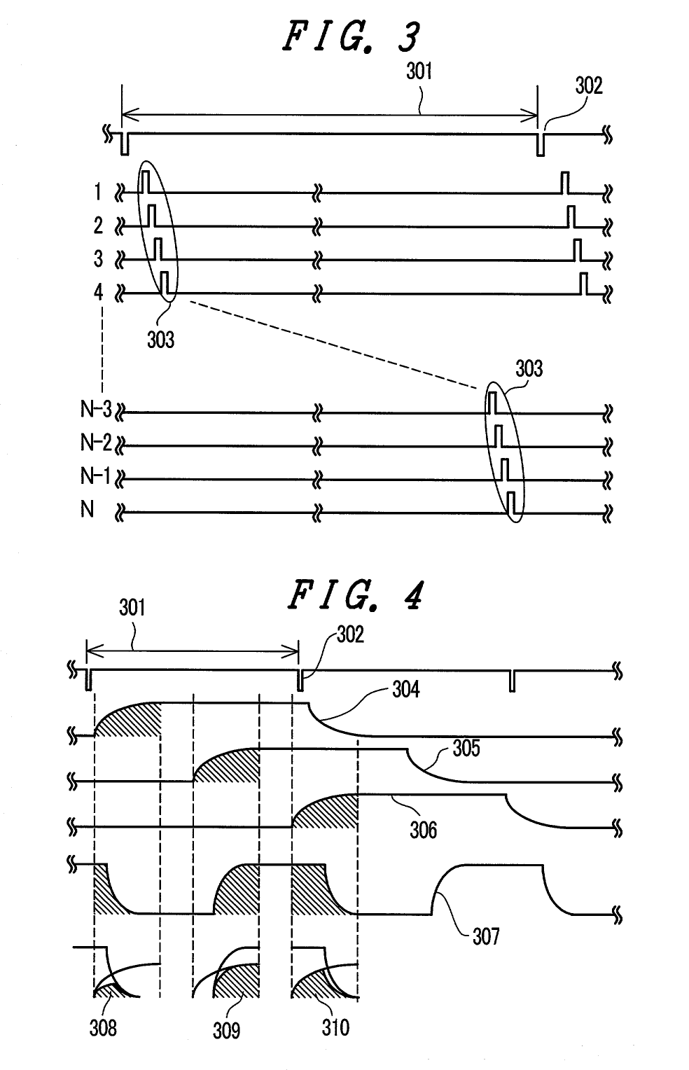

When the lighting start timing of a backlight which is intermittently lit in synchronism with the vertical synchronizing signal 302 is made the same as that in the related art shown in FIG. 4, the timing of application of grayscale voltage to the liquid crystal cells at the top end of the screen with respect to the timing of application of grayscale voltage to the liquid crystal cells in the center of the screen becomes symmetrical to the timing of application of grayscale voltage to the liquid crystal cells at the bottom end of the screen with respect to the timing of application of grayscale voltage to the liquid crystal cells in the center of the screen. Accordingly, the luminance 310 shown in FIG. 4 disappears, which is the luminance of the liquid crystal panel at the bottom end of the screen during the period of time in which the transmissivity of the liquid crystal cells lying at the bottom end of the screen is in the transient state before reaching the steady state, when display data at the bottom end of the screen changes from black to white, and only the luminance 311 is left, which is lower than the luminance 310 shown in FIG. 4 and is the luminance of the liquid crystal panel at each of the top and bottom ends of the screen during the period of time in which the transmissivity of the liquid crystal cells lying at each of the top and bottom ends of the screen is in the transient state before reaching the steady state, when display data at each of the top and bottom ends of the screen changes from black to white.

The driving timing chart of FIG. 6 has been described on the basis of the lighting start timing of the backlight which is the same as that in the related art shown in FIG. 4. Since the luminance variations in the top and bottom portions of the screen are symmetrical, even if the lighting start timing of the backlight is deviated, the contrast of a double contour in either of the top and bottom portions of the screen does not become high during the display of a moving image. Accordingly, by appropriately setting the timing of application of grayscale voltage to the liquid crystal cells at each of the top and bottom ends of the screen with respect to the timing of application of grayscale voltage to the liquid crystal cells in the center of the screen, it is possible to reduce a double contour which occurs during the display of a moving image, at both of the top and bottom ends of the screen.

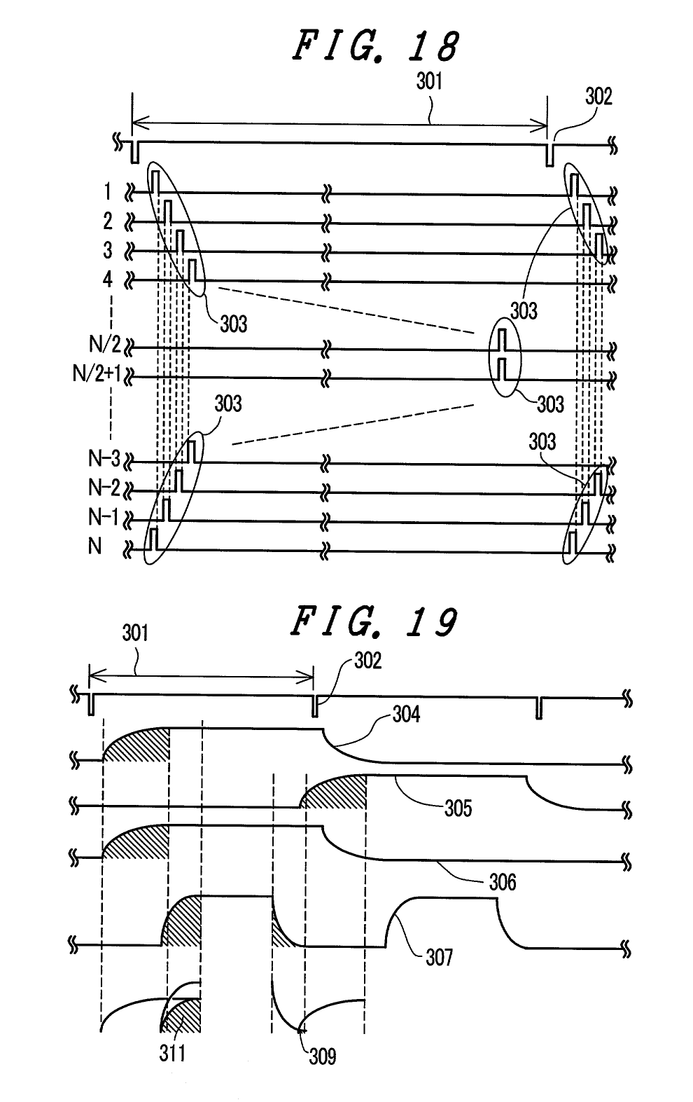

FIGS. 18 and 19 are driving timing charts of a liquid crystal display device according to a second embodiment of the invention. The second embodiment is realized by using the block diagram of the liquid crystal display device shown in FIG. 2. Symbols and numbers shown in FIGS. 18 and 19 are the same as those shown in FIGS. 5 and 6. The scanning-line selection method shown in FIG. 18 is the same as that shown in FIG. 5. In FIG. 5, the period of time required to complete scanning-line selection is slightly shorter than ½ of a vertical write period (frame period), whereas in FIG. 18, the period of time required to complete scanning-line selection is approximately the same as that adopted in the related art shown in FIG. 3, i.e. , slightly shorter than ½ of the vertical write period.

Specifically, in FIG. 18, the period of time from the start of selection of an arbitrary scanning line until the start of selection of the next scanning line is twice as long as that shown in FIG. 5, but the period of time for which the arbitrary scanning line is selected in FIG. 18 is the same as that shown in FIG. 5. It goes without saying that there is no problem even if the period of time for which an arbitrary scanning line is selected in FIG. 18 is made twice as long as that shown in FIG. 5 and the period of time required to complete scanning-line selection is made slightly shorter than the vertical write period (frame period).

Referring to FIG. 19, the lighting start timing of the back light which is intermittently lit in synchronism with the vertical synchronizing signal 302 is made the same as the timing at which after the application of grayscale voltage to the liquid crystal cells lying at each of the top and bottom ends of the screen, the transmissivity of each of the liquid crystal cells reaches an approximately steady state during the period of time in which the transmissivity of each of the liquid crystal cells is in the transient state before reaching the steady state.

In this case, the luminance 311 is the luminance of the liquid crystal panel during the period of time in which the transmissivity of the liquid crystal cells lying at each of the top and bottom ends of the screen is in the transient state before reaching the steady state, when display data at each of the top and bottom ends of the screen changes from black to white, and the luminance 309 is the luminance of the liquid crystal panel during the period of time in which the transmissivity of the liquid crystal cells lying in the center of the screen is in the transient state before reaching the steady state, when display data in the center of the screen changes from black to white.

In the second embodiment, since the luminance of the liquid crystal panel at each of the top and bottom ends of the screen gradually increases when display data changes from black to white, a double contour does not occur even if a moving image is displayed. In the center of the screen, when display data changes from black to white, the backlight is lit while the transmissivity of the liquid crystal cells in the center of the screen is in the steady state after the emission of light of extremely low luminance (low contrast). Although an emission of high luminance occurs and therefore, an extremely thin double contour appears, the image quality is improved in the entire screen. In addition, in the second embodiment, the period of time from the start of selection of an arbitrary scanning line until the start of selection of the next scanning line is made twice as long as that shown in FIG. 5 in terms of the response time of a variation in the transmissivity of the liquid crystal cells to the application of grayscale voltage and the luminance response time of the backlight. However, it goes without saying that in the case where the response time of avariation in the transmissivity of the liquid crystal cells to the application of grayscale voltage and the luminance response time of the back light are different from those shown in FIG. 19, the image quality can be improved by appropriately setting the period of time from the start of selection of an arbitrary scanning line until the start of selection of the next scanning line within the range of from once to twice as long as that shown in FIG. 5.

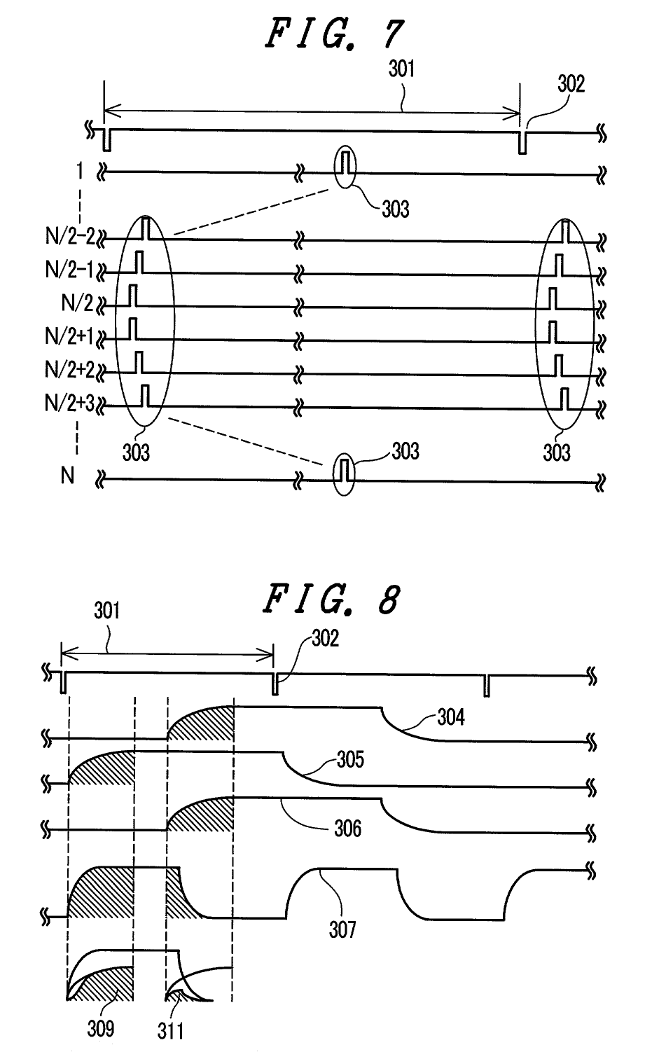

FIGS. 7 and 8 are driving timing charts of a liquid crystal display device according to a third embodiment of the invention. The third embodiment is realized by using the block diagram of the liquid crystal display device shown in FIG. 2. The s shown in FIGS. 7 and 8 are the same as those shown in FIGS. 5 and 6.

In the third embodiment, selection of scanning signal lines of a liquid crystal panel having N number of scanning signal lines and N lines of scanning electrodes is carried out at the timing shown in FIG. 7 by using the block diagram of the liquid crystal display device shown in FIG. 2 by the following method: Scanning-line selections are respectively started with the (N/2)-th line and the (N/2+1)-th line at the same time, and the scanning-line selection started with the (N/2)-th line is performed sequentially upwardly of the screen, while the scanning-line selection started with the (N/2+1)-th line is performed sequentially downwardly of the screen. The selection of scanning signal lines for one image is completed with the selection of both the first line and the N-th line. In this method, grayscale voltages corresponding to display data are applied to the respective liquid crystal cell S.

Referring to FIG. 8, the lighting start timing of the back light which is intermittently lit in synchronism with the vertical synchronizing signal 302 is made the same as the timing of application of grayscale voltage to the liquid crystal cell s in the center of the screen.

In this case, the luminance 309 is the luminance of the liquid crystal panel during the period of time in which the transmissivity of the liquid crystal cells lying in the center of the screen is in the transient state before reaching the steady state, when display data in the center of the screen changes from black to white, and the luminance 311 is the luminance of the liquid crystal panel during the period of time in which the transmissivity of the liquid crystal cells lying at each of the top and bottom ends of the screen is in the transient state before reaching the steady state, when display data at each of the top and bottom ends of the screen changes from black to white.

In FIG. 8, similarly to FIG. 6, the luminance 310 shown in FIG. 4 disappears, which is the luminance of the liquid crystal panel at the bottom end of the screen during the period of time in which the transmissivity of the liquid crystal cells lying at the bottom end of the screen is in the transient state before reaching the steady state, and only the luminance 311 is left, which is lower (lower in contrast) than the luminance 310 shown in FIG. 4 and is the luminance of the liquid crystal panel at each of the top and bottom ends of the screen during the period of time in which the transmissivity of the liquid crystal cells at each of the top and bottom ends of the screen is in the transient state before reaching the steady state.

In FIG. 8, the lighting start timing of the back light which is intermittently lit in synchronism with the vertical synchronizing signal 302 is made the same as the timing of application of grayscale voltage to the liquid crystal cells in the center of the screen. Accordingly, the gradual increase of the luminance 309 shown in FIG. 8 is slightly sluggish compared to the variation in the luminance 309, shown in FIG. 6, of the liquid crystal panel in the center of the screen during the period of time in which the transmissivity of the liquid crystal cells lying in the center of the screen is in the transient state before reaching the steady state.

However, in FIG. 8 as well, the luminance 311 of the liquid crystal panel at each of the top and bottom ends of the screen during the period of time in which the transmissivity of the liquid crystal cells lying at each of the top and bottom ends of the screen is in the transient state before reaching the steady state is similar to the luminance 311 shown in FIG. 6, and the contrast of a double contour in either of the top and bottom portions of the screen does not become high during the display of a moving image. Accordingly, by appropriately setting the timing of application of grayscale voltage to the liquid crystal cells at each of the top and bottom ends of the screen with respect to the timing of application of grayscale voltage to the liquid crystal cells in the center of the screen, it is possible to reduce a double contour which occurs during the display of a moving image, at both of the top and bottom ends of the screen.

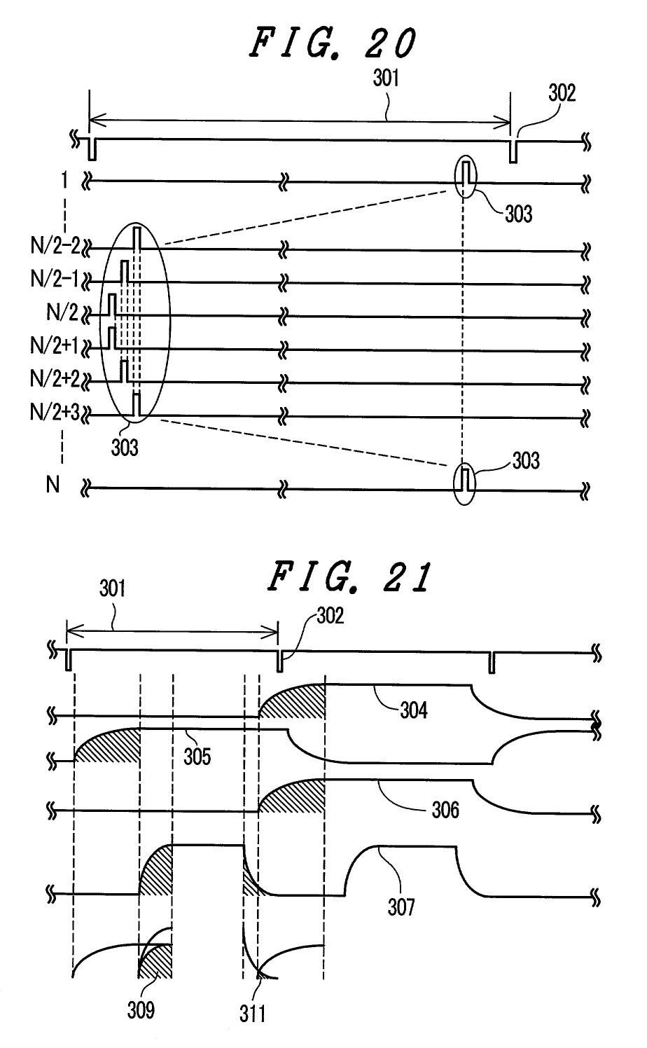

FIGS. 20 and 21 are driving timing charts of a liquid crystal display device according to a fourth embodiment of the invention. The fourth embodiment is realized by using the block diagram of the liquid crystal display device shown in FIG. 2. The s shown in FIGS. 20 and 21 are the same as those shown in FIGS. 5 and 6.

The scanning-line selection method shown in FIG. 20 is the same as that shown in FIG. 7. In FIG. 7, the period of time required to complete scanning-line selection is slightly shorter than ½ of the vertical write period (frame period), whereas in FIG. 20, the period of time required to complete scanning-line selection is approximately the same as that adopted in the related art shown in FIG. 3, i.e., slightly shorter than the vertical write period.

Specifically, in FIG. 20, the period of time from the start of selection of an arbitrary scanning line until the start of selection of the next scanning line is twice as long as that shown in FIG. 7, but the period of time for which the arbitrary scanning line is selected in FIG. 20 is the same as that shown in FIG. 7. It goes without saying that there is no problem even if the period of time for which an arbitrary scanning line is selected in FIG. 20 is made twice as long as that shown in FIG. 7 and the period of time required to complete scanning-line selection is made slightly shorter than the vertical write period (frame period).

Referring to FIG. 21, the lighting start timing of the back light which is intermittently lit in synchronism with the vertical synchronizing signal 302 is made the same as the timing at which the transmissivity of the liquid crystal cells changes from the transients tate to the steady state after the application of grayscale voltage to the liquid crystal cells lying in the center of the screen.

In this case, the luminance 309 is the luminance of the liquid crystal panel during the period of time in which the transmissivity of the liquid crystal cells lying in the center of the screen is in the transient state before reaching the steady state, when display data in the center of the screen changes from black to white, and the luminance 311 is the luminance of the liquid crystal panel during the period of time in which the transmissivity of the liquid crystal cells lying at each of the top and bottom ends of the screen is in the transient state before reaching the steady state, when display data at each of the top and bottom ends of the screen changes from black to white.

In the fourth embodiment, since the luminance of the liquid crystal panel in the center of the screen gradually increases when display data changes from black to white, a double contour does not occur even if a moving image is displayed. At each of the top and bottom ends of the screen, when display data changes from black to white, the backlight is lit while the transmissivity of the liquid crystal cells at each of the top and bottom ends of the screen is in the steady state after the emission of light of extremely low luminance (low contrast). Although an emission of high luminance occurs and therefore, an extremely thin double contour appears, the image quality is improved in the entire screen.

In the fourth embodiment, the period of time from the start of selection of an arbitrary scanning line until the start of selection of the next scanning line is made twice as long as that shown in FIG. 7 in terms of the response time of a variation in the transmissivity of the liquid crystal cells to the application of grayscale voltage and the luminance response time of the backlight. However, it goes without saying that in the case where the response time of a variation in the transmissivity of the liquid crystal cells to the application of grayscale voltage and the luminance response time of the backlight are different from those shown in FIG. 21, the image quality can be improved by appropriately setting the period of time from the start of selection of an arbitrary scanning line until the start of selection of the next scanning line with in the range of from once to twice as long as that shown in FIG. 7.

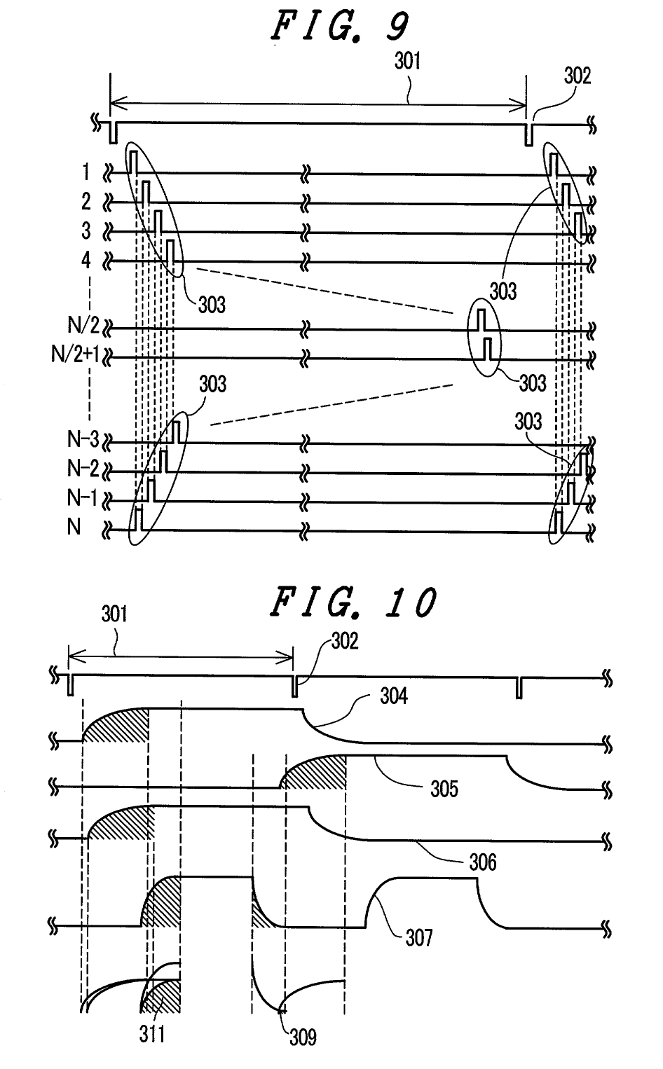

FIGS. 9 and 10 are driving timing charts of a liquid crystal display device according to a fifth embodiment of the invention. The fifth embodiment is realized by using the block diagram of the liquid crystal display device shown in FIG. 17. The s shown in FIGS. 9 and 10 are the same as those shown in FIGS. 5 and 6.

Referring to FIG. 9, from among the scanning signal lines of a liquid crystal panel having N number of scanning signal lines and N lines of scanning electrodes, the N-th line is selected after the first line is se lected, then the second line is selected after the N-th line is selected, then the (N−1)-th line is selected after the second line is selected, and subsequently, the selections of the remaining scanning lines are similarly sequentially performed. When the (N2+1)-th line has been selected after the (N/2)-th line has been selected, the selection of scanning signal lines for one image is completed.

The scanning-line selection is performed at the timing shown in FIG. 9, and the lighting start timing of the backlight which is intermittently lit in synchronism with the vertical synchronizing signal 302 shown in FIG. 10 is made the same as the timing at which after the application of grayscale voltage to the liquid crystal cells lying at each of the top and bottom ends of the screen, the transmissivity of each of the liquid crystal cells reaches an approximately steady state during the period of time in which the transmissivity of each of the liquid crystal cells is in the transient state before reaching the steady state.

In FIG. 9, the timing of application of grayscale voltage to the liquid crystal cells at the top end of the screen and the timing of application of grayscale voltage to the liquid crystal cells at the bottom end of the screen are deviated from each other by the period of time from the start of selection of an arbitrary scanning line until the start of selection of the next scanning line. In a liquid crystal panel having 1,024 (in length)×768 (in width) effective pixels, the total number of lines including the number of lines lying in its non-displ ay area is 800 to 808, although there is a difference between the numbers of lines of in dividual systems. Therefore, the selection time per line is approximately 21 μS in the case of a screen display frequency of 60 Hz (16.7 mS), and is not greater than 1/100 of the response time of a liquid crystal having a normal response time. Accordingly, such a period of time is a negligible time difference.

Accordingly, the respective driving timing charts of FIGS. 9 and 10 are similar to those of FIGS. 18 and 19, whereby it is possible to obtain an image-quality improvement effect similar to that achieved in the second embodiment described above with reference to FIGS. 18 and 19.

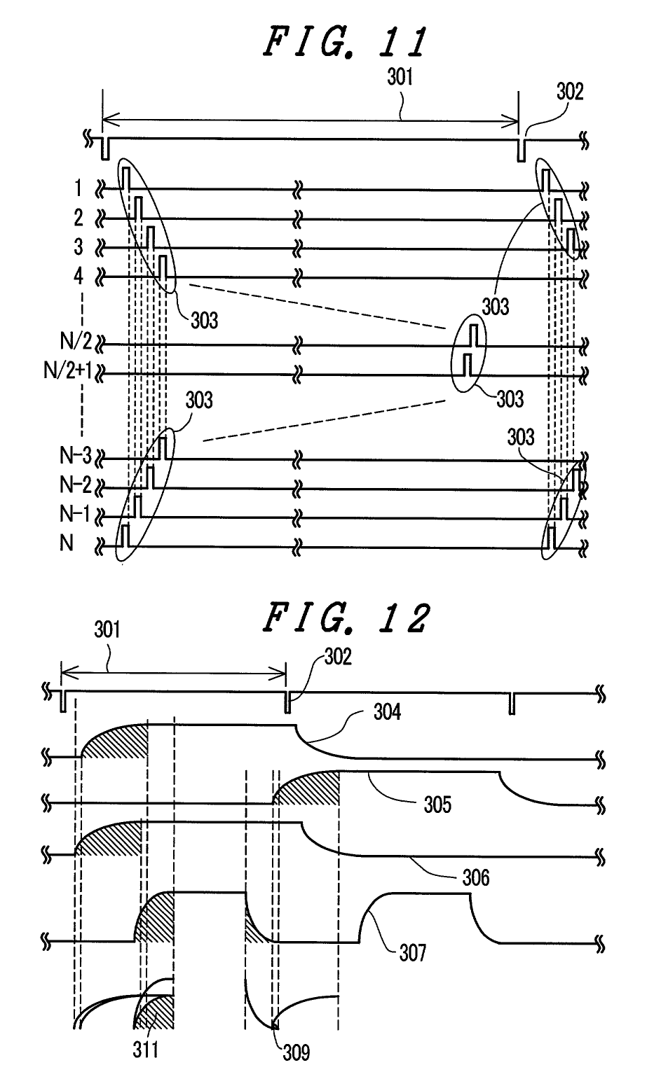

FIGS. 11 and 12 are driving timing charts of a liquid crystal display device according to a sixth embodiment of the invention. The sixth embodiment is realized by using the block diagram of the liquid crystal display device shown in FIG. 17. The s shown in FIGS. 11 and 12 are the same as those shown in FIGS. 5 and 6.

Referring to FIG. 11, from among the scanning signal lines of a liquid crystal panel having N number of scanning signal lines and N lines of scanning electrodes, the first line is selected after the N-th line is selected, then the (N−1)-th line is selected after the first line is selected, then the second line is selected after the (N−1)-th line is selected, and subsequently, the selections of the remaining scanning lines are similarly sequentially performed. When the (N/2)-th line is selected after the (N/2+1)-th line has been selected, the selection of scanning signal lines for one image is completed.

The scanning-line selection is performed at the timing shown in FIG. 11, and the lighting start timing of the back light which is intermittently lit in synchronism with the vertical synchronizing signal 302 shown in FIG. 12 is made the same as the timing at which after the application of grayscale voltage to the liquid crystal cells lying at each of the top and bottom ends of the screen, the transmissivity of each of the liquid crystal cells reaches an approximately steady state during the period of time in which the transmissivity of each of the liquid crystal cells is in the transient state before reaching the steady state.

The difference between FIGS. 9 and 11 is that in FIG. 9, scanning-line selection is started at the top end of the screen, whereas in FIG. 11, scanning-line selection is started at the bottom end of the screen. As described above, in a liquid crystal panel having 1,024 (in length)×768 (in width) effective pixels, the time difference between the start of selection of an arbitrary scanning line and the start of selection of the next scanning line is approximately 21 [symbol] S, and is not greater than 1/100 of the response time of a liquid crystal having a normal response time. Accordingly, such a period of time is a negligible time difference.

Accordingly, the respective driving timing charts of FIGS. 11 and 12 are similar to those of FIGS. 9 and 10 and hence those of FIGS. 18 and 19, whereby it is possible to obtain an image-quality improvement effect similar to that achieved in the second embodiment described above with reference to FIGS. 18 and 19.

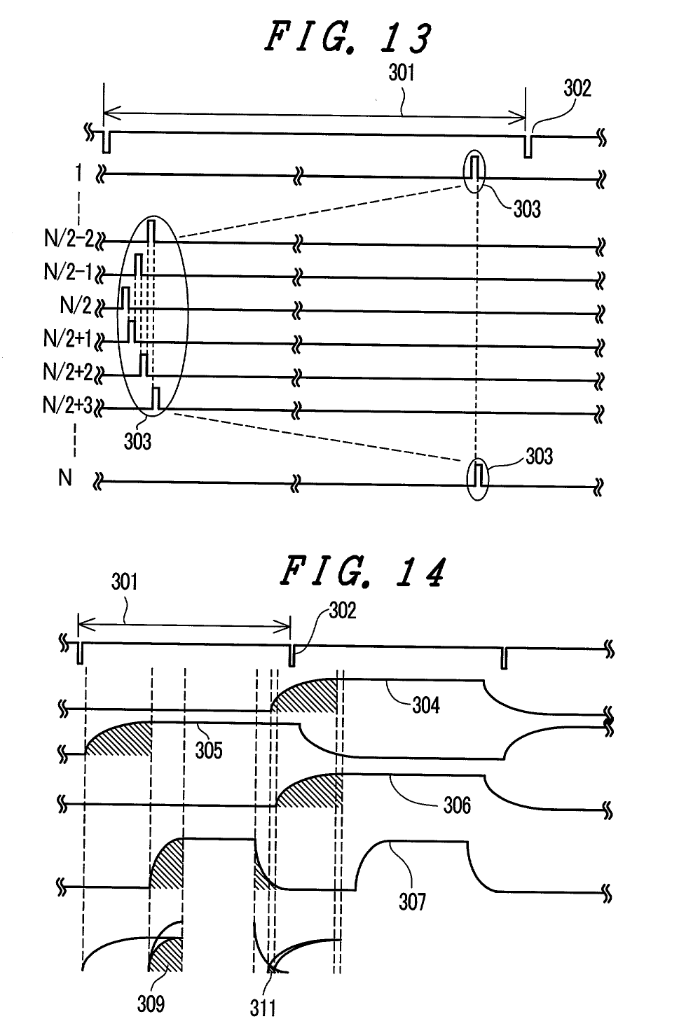

FIGS. 13 and 14 are driving timing charts of a liquid crystal display device according to a seventh embodiment of the invention. The seventh embodiment is realized by using the block diagram of the liquid crystal display device shown in FIG. 17. The s shown in FIGS. 13 and 14 are the same as those shown in FIGS. 5 and 6.

Referring to FIG. 13, from among the scanning signal lines of a liquid crystal panel having N number of scanning signal lines and N lines of scanning electrodes, the (N/2+1)-th line is selected after the (N/2)-th line is selected, then the (N/2−1)-th line is selected after the (N/2+1)-th line is selected, then the (N/2+2)-th line is selected after the (N/2−1)-th line is selected, and subsequently, the selections of the remaining scanning lines are similarly sequentially performed. When the N-th line is selected after the first line has been selected, the selection of scanning signal lines for one image is completed.

The scanning-line selection is performed at the timing shown in FIG. 13, and the lighting start timing of the backlight which is intermittently lit in synchronism with the vertical synchronizing signal 302 shown in FIG. 14 is made the same as the timing at which after the application of grayscale voltage to the liquid crystal cells lying in the center of the screen, the transmissivity of the liquid crystal cells changes from the transient state to the steady state.

The difference between the timing of application of grayscale voltage to the liquid crystal cels along the (N/2+1)-th line in the center of the screen and the timing of application of grayscale voltage to the liquid crystal cell along the (N/2)-th line in the center of the screen, and the difference between the timing of application of grayscale voltage to liquid crystal cells at the bottom end of the screen and the timing of application of grayscale voltage to liquid crystal cells at the top end of the screen, are each equivalent to the period of time from the start of selection of an arbitrary scanning line until the start of selection of the next scanning line. However, as described above, in a liquid crystal panel having 1,024 (in length)×768 (in width) effective pixels, the time difference between the start of selection of an arbitrary scanning line and the start of selection of the next scanning line is approximately 21 z,900 S, and is not greater than 1/100 of the response time of a liquid crystal having a normal response time. Accordingly, such a period of time is a negligible time difference.

Accordingly, according to the respective driving timing charts of FIGS. 13 and 14, it is possible to obtain an image-quality improvement effect similar to that achieved in the fourth embodiment described above with reference to FIGS. 20 and 21.

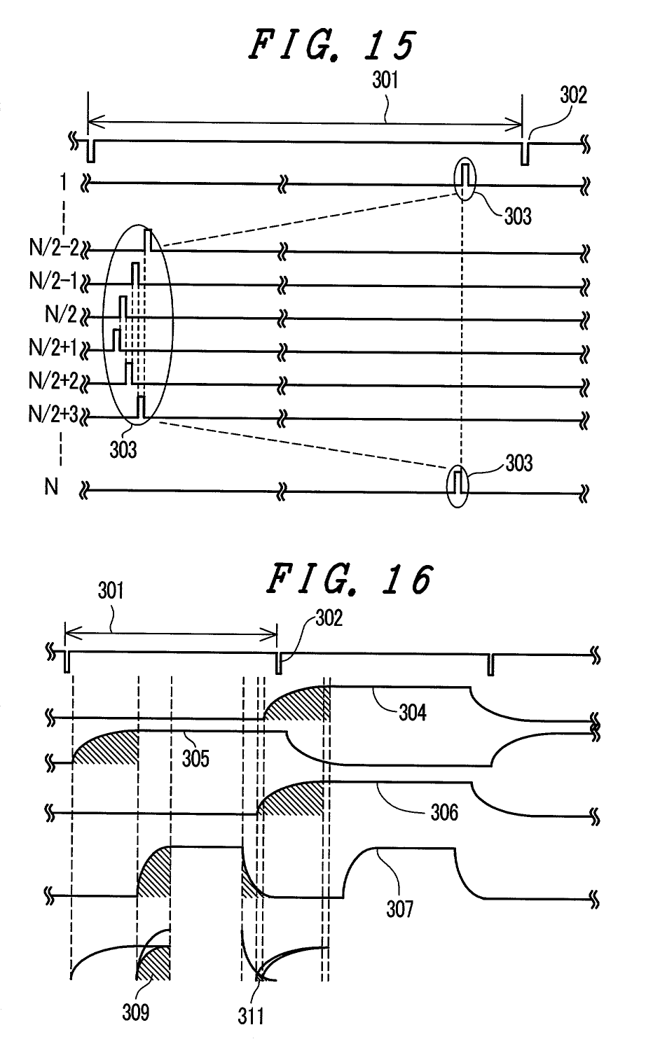

FIGS. 15 and 16 are driving timing charts of a liquid crystal display device according to an eighth embodiment of the invention. The eighth embodiment is realized by using the block diagram of the liquid crystal display device shown in FIG. 17. The s shown in FIGS. 15 and 16 are the same as those shown in FIGS. 5 and 6.

Referring to FIG. 15, from among the scanning signal lines of a liquid crystal panel having N number of scanning signal lines and N lines of scanning electrodes, the (N/2)-th line is selected after the (N/2+1)-th line is selected, then the (N/2+1)-th line is selected after the (N/2)-th line is selected, then the (N/2−1)-th line is selected after the (N/2+2)-th line is selected, and subsequently, the selections of the remaining scanning lines are similarly sequentially performed. When the first line is selected after the N-th line has been selected, the selection of scanning signal lines for one image is completed.

The scanning-line selection is performed at the timing shown in FIG. 15, and the lighting start timing of the back light which is intermittently lit in synchronism with the vertical synchronizing signal 302 shown in FIG. 16 is made the same as the timing at which after the application of grayscale voltage to the liquid crystal cells lying in the center of the screen, the transmissivity of the liquid crystal cells changes from the transient state to the steady state.

The difference between the timing of application of grayscale voltage to the liquid crystal cells along the (N/2+1)-th line in the center of the screen and the timing of application of grayscale voltage to the liquid crystal cell along the (N/2)-th line in the center of the screen, and the difference between the timing of application of grayscale voltage to liquid crystal cells at the bottom end of the screen and the timing of application of grayscale voltage to liquid crystal cells at the top end of the screen, are each equivalent to the period of time from the start of selection of an arbitrary scanning line until the start of selection of the next scanning line. However, as described above, in a liquid crystal panel having 1,024 (in length)×768 (in width) effective pixels, the time difference between the start of selection of an arbitrary scanning line and the start of selection of the next scanning line is approximately 21 μS, and is not greater than 1/100 of the response time of a liquid crystal having a normal response time. Accordingly, such a period of time is a negligible time difference.

Accordingly, according to the respective driving timing charts of FIGS. 15 and 16, it is possible to obtain an image-quality improvement effect similar to that achieved in the fourth embodiment described above with reference to FIGS. 20 and 21.

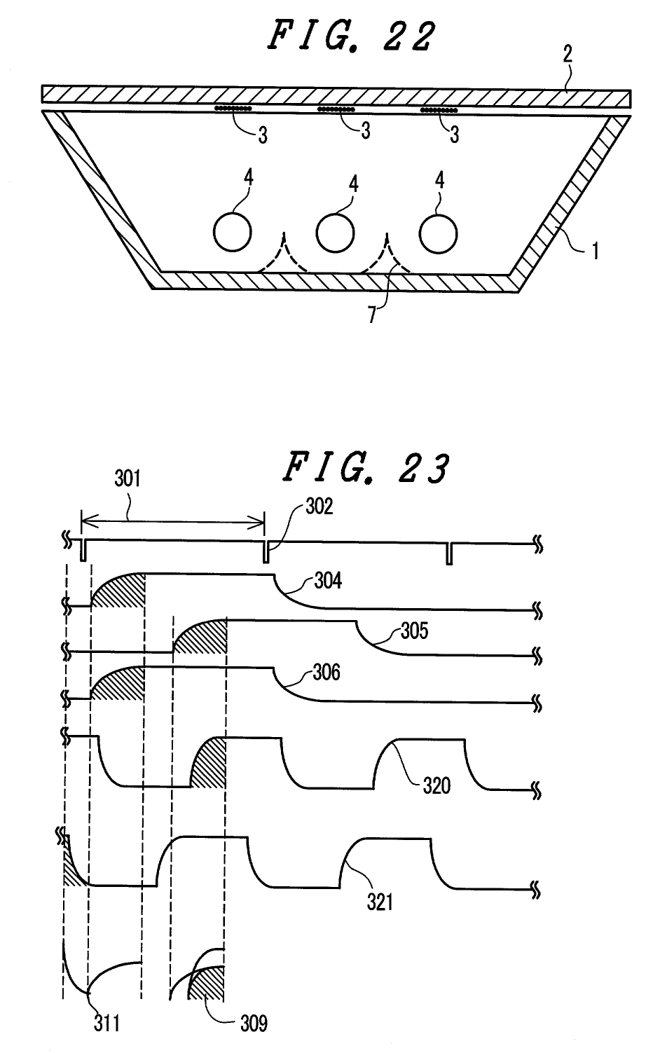

FIG. 22 is a schematic cross-sectional view showing a ninth embodiment of the invention and aiding in describing an example of the construction of a direct backlight which uses a cold-cathode fluorescent lamp as its light source. Referring to FIG. 22, in the direct backlight, a reflecting sheet 7 for efficiently using light of a plurality of cold-cathode fluorescent lamps 4 is provided at the bottom of a frame 1. A diffusion sheet 2 is provided on a liquid-crystal-panel side (not shown) of the direct backlight.

Formed on the bottom surface of the diffusing sheet 2 are light-shielding dots 3 for adjusting the luminance of light of the corresponding cold-cathode fluorescent lamps 4 disposed directly below the respective light-shielding dots 3. Related arts of this kind of direct backlight have been disclosed in, for example, Japanese Patent Laid-Open Nos. 242219/1999 and 84377/1999.

In the direct back light shown in FIG. 22, select ion of scanning signal lines of a liquid crystal panel having N number of scanning signal lines and N lines of scanning electrodes is carried out at the timing shown in FIG. 5 by using the block diagram of the liquid crystal display device shown in FIG. 2 by the following method: Scanning-line selections are respectively started with the first line and the N-th line at the same time, and the scanning-line selection started with the first line is performed sequentially downwardly of the screen, while the scanning-line selection started with the N-th line is performed sequentially upwardly of the screen. The selection of scanning signal lines for one image is completed with the selection of both the (N/2)-th line and the (N/2+1)-th line.

FIG. 23 is a driving timing chart of a liquid crystal display device according to the ninth embodiment of the invention.

The lighting start timing of the back light which is intermittently lit in synchronism with the vertical synchronizing signal 302 shown in FIG. 23 is made the same as the timing of a backlight luminance 320 as to the backlight lamp 4 which illuminates liquid crystal cells near the center of the screen, and as the timing of a backlight luminance 321 as to the backlight lamps 4 which illuminate liquid crystal cells in the top and bottom portions of the screen.

When scanning-line selection is performed at the above-described timing while the intermittent lighting of the backlight is being performed, the luminance 309 becomes the luminance of the liquid crystal panel in the center of the screen during the period of time in which the transmissivity of liquid crystal cells lying in the center of the screen is in the transient state before reaching the steady state, when display data in the center of the screen changes from black to white, while the luminance 311 becomes the luminance of the liquid crystal panel at each of the top and bottom ends of the screen when display data at each of the top and bottom ends of the screen changes from black to white.

In the center of the screen, when the display data changes from black to white, the waveform of the liquid crystal panel during the period of time in which the transmissivity of the liquid crystal cells is in the transient state before reaching the steady state is such that the luminance of the liquid crystal panel gradually increases as shown at 309, and in addition, a variation in the luminance of the liquid crystal panel is faster than the response of a variation in the transmissivity of the liquid crystal cells to the application of grayscale voltage to the liquid crystal cells. Accordingly, the image quality of the liquid crystal display device is improved.

At each of the top and bottom ends of the screen, when the display data changes from black to white, the backlight is lit while the transmissivity of the liquid crystal cells at each of the top and bottom ends of the screen is in the steady state after the emission of light of extremely low luminance (low contrast) . Accordingly, an emission of high luminance occurs and therefore, a double contour can be made extremely thin, the image quality is improved in the entire screen.

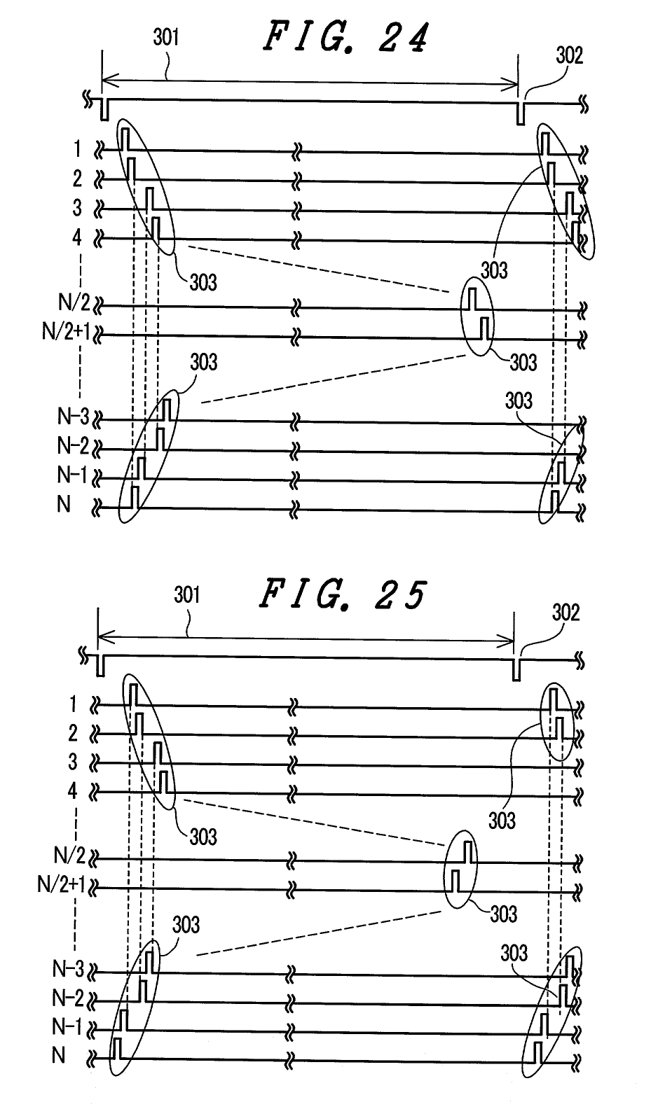

FIG. 24 shows an example in which scanning signal lines are alternately scanned by two lines at a time. The scanning signal lines are alternately scanned in such a manner that the top first and second lines are scanned, then the bottom N-th and (N−1)-th lines are scanned, then the top third and fourth lines are scanned, then the bottom (N−2)-th and (N−3)-th line are scanned, and so on. By alternately scanning the scanning signal lines, it is possible to average and thin a double contour at the top and bottom portions of the screen, whereby the image quality of the liquid crystal display device is improved. The unit of scanning is not limited to two lines, and may also be two or four lines. In VGA, SVGA and XGA, scanning may be performed in units of three or four lines. In SXGA, scanning may be performed in units of four lines. Incidentally, in the fourth embodiment, the terms VGA, SVGA, XGA and SXGA are used to represent the numbers of scanning lines defined by the respective terms, and the invention can be similarly applied to panels having different horizontal pixel sizes. For instance, a wide type such as WXGA (Wide-XGA), which has the same number of pixels in the longitudinal direction as XGA and more pixels in the horizontal direction than XGA, can be handled as XGA.

FIG. 25 shows an example in which the starting point of scanning differs from that of the example shown in FIG. 24. Both examples differ in that scanning is started at the top side of the screen in the example shown in FIG. 24, whereas in the example shown in FIG. 25, scanning is started at the bottom side of the screen. Even with the method shown in FIG. 25, it is possible to obtain an effect equivalent to that of the method shown in FIG. 24.

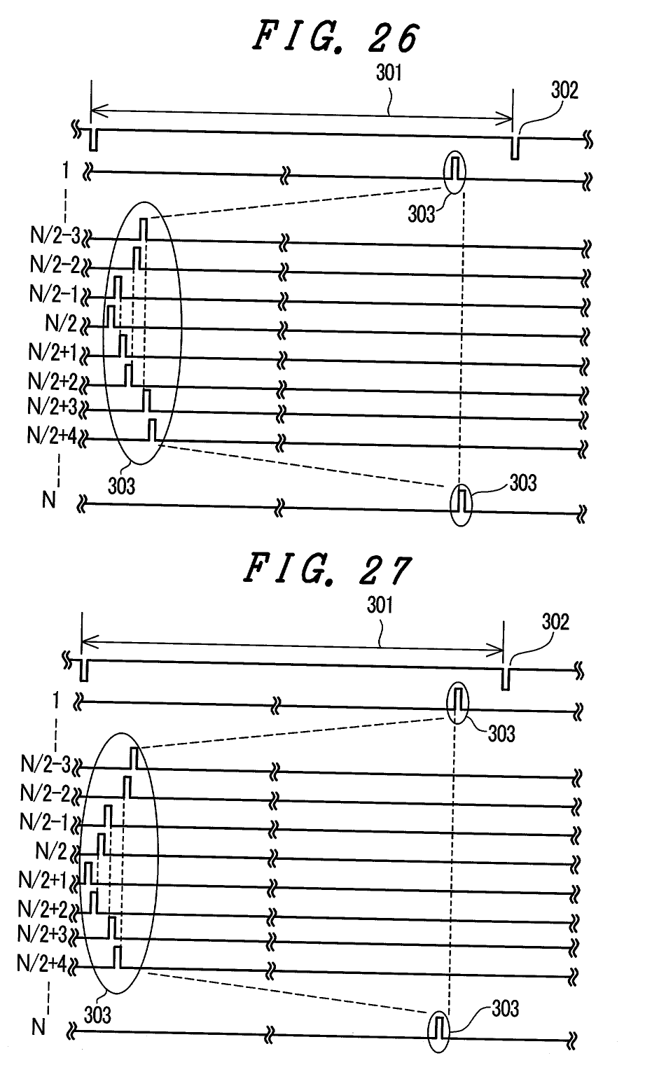

FIG. 26 shows an example in which the scanning shown in FIG. 24 is performed to proceed from the center toward the top and bottom of the screen. As shown in FIG. 26, the (N/2)-th and (N/2−1)-th lines are scanned, then the bottom (N/2+1)-th and (N/2+2)-th lines are scanned, then the top (N/2−2)-th and (N/2−3)-th line are scanned, and then the bottom (N/2+3)-th and (N/2+4)-th lines are scanned. Even in this method, it is possible to obtain an image-quality improvement effect similar to that achieved in the example shown in FIG. 24.

FIG. 27 shows an example in which the scanning shown in FIG. 26 is started at the bottom of the screen. Even in this method, it is possible to obtain an image-quality improvement effect similar to that achieved in the example shown in FIG. 24.

As is apparent from the foregoing description, according to the invention, it i s possible to symmetrize a double contour which asymmetrically occurs in the top and bottom portions of a screen during the display of a moving image. In addition, it is possible to reduce the strength of the double contour. Accordingly, it is possible to provide a liquid crystal display device capable of restraining the degradation of image quality and displaying a high-quality moving image.

What is claimed is:

1. A liquid crystal display device comprising:
a liquid crystal panel having a plurality of drain signal lines and a plurality of scanning signal lines on at least one of a pair of substrates disposed in opposition to each other, and a liquid crystal layer formed between the pair of substrates;
a display control unit which applies a voltage according to a display image signal on the basis of a display image signal and a timing signal which are externally inputted; and
a light source which illuminates the liquid crystal panel,
wherein selection of the scanning signal lines being started with a line lying at one end of a screen and with a line lying at the other end of the screen, scanning-signal-line selection started at the one end of the screen being sequentially performed to proceed toward the other end of the screen, scanning-signal-line selection started at the other end of the screen being sequentially performed to proceed toward the one end of the screen scanning-signal-line selection in an area corresponding to a display area of the liquid crystal display panel being completed when the scanning-signal-line selection started at the one end of the screen and the scanning-signal-line selection started at the other end of the screen respectively select most mutually adjacent separate scanning signal lines, the light source which illuminates the liquid crystal panel being lit and extinguished in a predetermined relationship with writing of the display image signal to the screen.

2. A liquid crystal display device comprising:
a liquid crystal panel having a plurality of drain signal lines and a plurality of scanning signal lines on at least one of a pair of substrates disposed in opposition to each other, and a liquid crystal layer clamped between the pair of substrates;
a display control unit which applies a voltage according to a display image signal on the basis of a display image signal and a timing signal which are externally inputted; and
a light source which illuminates the liquid crystal panel,
where in selection of the scanning signal lines being sequentially performed to proceed from one of adjacent scanning signal lines toward one end of a screen and to proceed from the other of the adjacent scanning signal lines toward the other end of the screen, the light source which illuminates the liquid crystal panel being lit and extinguished in a predetermined relationship with writing of the display image signal to the screen.

3. A liquid crystal display device comprising:
a liquid crystal panel having a plurality of drain signal lines and a plurality of scanning signal lines on at least one of a pair of substrates disposed in opposition to each other, and a liquid crystal layer clamped between the pair of substrates;
a display control unit which applies a voltage according to a display image signal on the basis of a display image signal and a timing signal which are externally inputted; and
a light source which illuminates the liquid crystal panel,
wherein selection of the scanning signal lines being started with a line lying at one end of a screen and with a line lying at the other end of the screen, scanning-signal-line selection started at the one end of the screen being sequentially performed to proceed toward the other end of the screen, scann ing-signal-line selection started at the other end of the screen being sequentially performed to proceed toward the one end of the screen, the scanning-signal-line selection started at the one end and the scanning-signal-line selection started at the other end being alternately performed, scanning-signal-line selection in an area corresponding to a display area of the liquid crystal display panel being completed when the scanning-signal-line selection started at the one end of the screen and the scanning-signal-line selection started at the other end of the screen respectively select most mutually adjacent separate scanning signal lines, the light source which illuminates the liquid crystal panel being lit and extinguished in a predetermined relationship with writing of the display image signal to the screen.

4. A liquid crystal display device comprising:
a liquid crystal panel having a plurality of drain signal lines and a plurality of scanning signal lines on at least one of a pair of substrates disposed in opposition to each other, and a liquid crystal layer clamped between the pair of substrates;
a display control unit which applies a voltage according to a display image signal on the basis of a display image signal and a timing signal which are externally inputted; and
a light source which illuminates the liquid crystal panel,
wherein selection of the scanning signal lines being sequentially performed to proceed from one of adjacent scanning signal lines toward one end of a screen and to proceed from the other of the adjacent scanning signal lines toward the other end of the screen, scanning-signal-line selection which proceeds from the one of the adiacent scanning signal lines toward the one end of the screen and scanning-signal-line selection which proceeds from the other of the adjacent scanning signal lines toward the other end of the screen being alternately performed, the light source which illuminates the liquid crystal panel being lit and extinguished in a predetermined relationship with writing of the display image signal to the screen.

5. A liquid crystal display device comprising:
a liquid crystal panel having a plurality of drain signal lines and a plurality of scanning signal lines on at least one of a pair of substrates disposed in opposition to each other, and a liquid crystal layer clamped between the pair of substrates;
a display control unit which applies a voltage according to a display image signal on the basis of a display image signal and a timing signal which are externally inputted; and
a light source which illuminates the liquid crystal panel,
wherein selection of the scanning signal lin es being started with a line lying at one end of a screen and with a line lying at the other end of the screen, scanning-signal-line selection started at the one end of the screen being sequentially performed to proceed toward the other end of the screen, scanning-signal-line selection started at the other end of the screen being sequentially performed to proceed toward the one end of the screen, the light source which illuminates the liquid crystal panel being intermittently lit.

6. A liquid crystal display device comprising:
a liquid crystal panel having a plurality of drain signal lines and a plurality of scanning signal lines on at least one of a pair of substrates disposed in opposition to each other, and a liquid crystal layer clamped between the pair of substrates;
a display control unit which applies a voltage according to a display image signal on the basis of a display image signal and a timing signal which are externally inputted; and
a light source which illuminates the liquid crystal panel,
wherein selection of the scanning signal lines being sequentially performed to proceed from one of adjacent scanning signal lines toward one end of a screen and to proceed from the other of the adjacent scanning signal lines toward the other end of the screen, the light source which illuminates the liquid crystal panel being intermittently lit.

7. A liquid crystal display device comprising:
a liquid crystal panel having a plurality of drain signal lines and a plurality of scanning signal lines on at least one of a pair of substrates disposed in opposition to each other, and a liquid crystal layer clamped between the pair of substrates;
a display control unit which applies a voltage according to a display image signal on the basis of a display image signal and a timing signal which are externally inputted; and
a light source which illuminates the liquid crystal panel,
wherein selection of the scanning signal lines being started with a line lying at one end of a screen and with a line lying at the other end of the screen, scanning-signal-line selection started at the one end of the screen being sequentially performed to proceed toward the other end of the screen, scanning-signal-line selection started at the other end of the screen being sequentially performed to proceed toward the one end of the screen, the scanning-signal-line selection started at the one end and the scanning-signal-line selection started at the other end being alternately performed, the light source which illuminates the liquid crystal panel being intermittently lit.

8. A liquid crystal display device comprising:
a liquid crystal panel having a plurality of drain signal lines and a plurality of scanning signal lines on at least one of a pair of substrates disposed in opposition to each other, and a liquid crystal layer clamped between the pair of substrates;
a display control unit which applies a voltage according to a display image signal on the basis of a display image signal and a timing signal which are externally inputted; and a light source which illuminates the liquid crystal panel,
wherein selection of the scanning signal lines being sequentially performed to proceed from one of adjacent scanning signal lines toward one end of a screen and to proceed from the other of the adjacent scanning signal lines toward the other end of the screen, scanning-signal-lines selection which proceeds from the one of the adjacent scanning signal lines toward the one end of the screen and scanning-signal-line selection which proceeds from the other of the adjacent scanning signal lines toward the other end of the screen being alternately performed, the light source which illuminates the liquid crystal panel being intermittently lit.

9. A liquid crystal display device according to claim 5, wherein scanning-signal-line selection in an area corresponding to a display area of the liquid crystal panel is completed when the scanning-signal-line selection started at the one end of the screen and the scanning-signal-line selection started at the other end of the screen respectively select most mutually adjacent separate scanning signal lines.

10. A liquid crystal display device according to claim 5, further comprising a scanning driver circuit which supplies scanning signals to the scanning signal lines and signal driver circuits which supply video signals to video signal lines, the signal driver circuits being disposed on the top side and the bottom side of the liquid crystal display device, the video signal lines being connected to either one of the signal driver circuits disposed on the topside and the bottom side.

11. A liquid crystal display device according to claim 6, wherein the selection of the scanning signal lines which proceeds toward the one end of the screen and the selection of the scanning signal lines which proceeds toward the other end of the screen are performed at approximately the same time.

12. A liquid crystal display device according to claim 10, where in the selection of the scanning signal lines which proceeds toward the one end of the screen and the selection of the scanning signal lines which proceeds toward the other end of the screen are performed at approximately the same time.

13. A liquid crystal display device according to claim 6, further comprising a scanning driver circuit which supplies scanning signals to the scanning signal lines and signal driver circuits which supply video signals to video signal lines, the signal driver circuits being disposed on the top side and the bottom side of the liquid crystal display device, the video signal lines being connected to either one of the signal driver circuits disposed on the topside and the bottom side.

14. A liquid crystal display device according to claim 6, wherein the selection of the scanning signal lines sequentially performed to proceed from the one of the adjacent scanning signal lines toward the one end of the screen and to proceed from the other of the adjacent scanning signal lines toward the other end of the screen are performed at approximately the same time.
